(19) United States
(12) Patent Application Publication
(10) Pub. No.: US 2005/0029839 A1
(43) Pub. Date: Feb. 10, 2005

(54) Process for producing a motor vehicle roof with a roof module

(75) Inventor: Thomas Stemmer, Muenchen (DE)

Correspondence Address: NIXON PEABODY, LLP, 401 9TH STREET, NW, SUITE 900, WASHINGTON, DC, 20004-2128, US

(73) Assignee: Webasto AG, Stockdorf (DE)

(21) Appl. No.: 10/931,961

(22) Filed: Sep. 2, 2004

(30) Foreign Application Priority Data
Nov. 12, 2002 (DE) 102 52 912.4

(51) Int. Cl. B60J 7/00

(52) U.S. Cl. 296/215

(57) ABSTRACT

A process for producing a motor vehicle roof with a roof module (8), and a roof module produced thereby, which is formed of a composite component (7) with an outer roof skin (8) and a stiffening structure (9) which is attached to its inside, the composite component (7) being formed with a roof opening (12) and with a roof closing unit (13) which closes the roof opening (12) added to it. The composite component (7) is produced, on the one hand, with a dimensioning and surface configuration matched to a given roof closing unit (13), and on the other hand, with a dimensioning matched to a given body roof frame (4). In this manner, a roof closing unit that is not designed for the given body roof frame part can be fitted thereto.

### BACKGROUND OF THE INVENTION

1. Field of the Invention

The invention relates to a process for producing a motor vehicle roof with a roof module which is formed as a composite component with an outer roof skin and a stiffening structure which is attached to its inside, the composite component being formed with a roof opening and with a roof closing unit which closes the roof opening added to it. Furthermore, the invention relates to a motor vehicle roof with a roof module which is formed as a composite component with an outer roof skin and a stiffening structure which is attached to its inside, the composite component being formed with a roof opening and having a roof closing unit which closes the roof opening.

German Patent DE 199 46 804 C2 and corresponding U.S. Pat. No. 6,409,258 discloses a motor vehicle roof module which has a rigid roof skin and a support structure which is attached to it and which is formed as an inside shell of plastic foam which has been foamed on the inside surface of the roof skin. The roof module contains a roof opening for a sliding roof. A sliding roof frame is attached to the plastic foam inside shell at several points, which are spaced apart from one another and which are distributed around the roof opening, by means of fasteners which are present at these points. This roof module, like the sliding roof which is held in it, is re-designed each time for a particular motor vehicle roof.

### SUMMARY OF THE INVENTION

A primary object of the present invention is to improve the initially named process in a manner which enables economical preparation of motor vehicle roof modules that are suitable for a number of different motor vehicle roofs and a motor vehicle roof with such a roof module.

This object is achieved in accordance with the invention in that the composite component is produced, on the one hand, depending on a given roof closing unit in its dimensioning and in its surface configuration with matching to this roof closing unit, and on the other hand, depending on a given body-side roof frame in its dimensioning with edge-side matching to the roof frame. The composite component forms the transition between the roof closing unit and the body-side roof frame. Since the roof frame is dictated by the configuration of the shell, the comparatively economically producible composite component in its structural design is matched to the given roof frame. Thus, only a molding or foaming tool with which the composite component is produced need be made and matched to the dimensions of the composite component which are necessary in each case. This molding or foaming tool is however much more economical compared to tools and production means for producing the conventionally used metal frame of the roof module.

Another major advantage is the likewise existing possibility of simple matching of the composite component to different roof closing units which are designed for covering a roof opening which has been formed in the composite component or also covering of several roof openings. Thus, an already available roof closing unit, for example, a sliding roof, a spoiler roof or also a cover which can be attached permanently to the roof module can be used for the motor vehicle roof module. The composite component which is used as the frame for the roof closing unit is likewise easily matched to the selected roof closing unit. The respective new design of a roof closing unit or matching of an existing roof closing unit is thus not necessary.

Preferably, the roof skin is formed from plastic or from metal and the stiffening structure is attached to the inside of the roof skin as a foamed-on part which contains the reinforcing material. A process for producing such a composite component is disclosed for example in European Patent Application EP 1 172 282 A2 and corresponding published U.S. Patent Application 20020021027 A1. The reinforcing material is, for example, a honeycomb structure which is made from paper or cardboard and which is foamed with polyurethane foam to the roof skin.

In one especially preferred procedure, the surface of the cover of the roof closing unit and the surface of the roof skin are produced with an identical appearance and especially with a glassy or glass-like appearance. In the past, large roof systems were developed to fit the respective vehicle, and generally a predominant number of the parts had to be matched due to different roof sizes and roof contours. When glass was used in large roof systems and a uniform appearance was desirable, in these glass roofs, the expensive and also heavy material glass for reasons of optical uniformity had to be used not only in the transparent areas of roof openings, but also in the edge-side areas without transparency. By using the composite component in accordance with the invention with a surface which is optically matched to the roof closing unit and feasibly also to the surface of the body-mounted roof frame and especially has a glass-like appearance, when the roof closing unit has at least one cover part of glass, the composite component, which can be produced comparatively easily and economically, can assume the function of glass in the areas in which transparency is not necessary. Thus, large roof systems can be more economically produced as motor vehicle roof modules with glass parts and glass-like parts and can also be matched in a shorter time to the given motor vehicle roofs or roof frames.

The object is achieved by a motor vehicle roof in which the composite component is produced, on the one hand, depending on a given roof closing unit in its dimensioning and in its surface configuration, and on the other hand, depending on a given body-side roof frame in its dimensioning in a manner that enables the roof to be produced much more economically as a result of the above described advantages.

One embodiment of the motor vehicle roof module is explained in detail below with reference to the accompanying drawings.

### BRIEF DESCRIPTION OF THE DRAWINGS

FIG. 1 shows is a top view a motor vehicle roof with a schematically shown motor vehicle roof module;

FIG. 2 is a perspective view of an unfinished body of a motor vehicle;

FIG. 3 is a cross-sectional view of a portion of the motor vehicle roof with the motor vehicle roof module;

FIG. 4 is a lengthwise sectional view of the motor vehicle roof module at the front transverse roof frame of the motor vehicle roof; and

FIG. 5 is a lengthwise sectional view the motor vehicle roof module at the rear transverse roof frame of the motor vehicle roof.

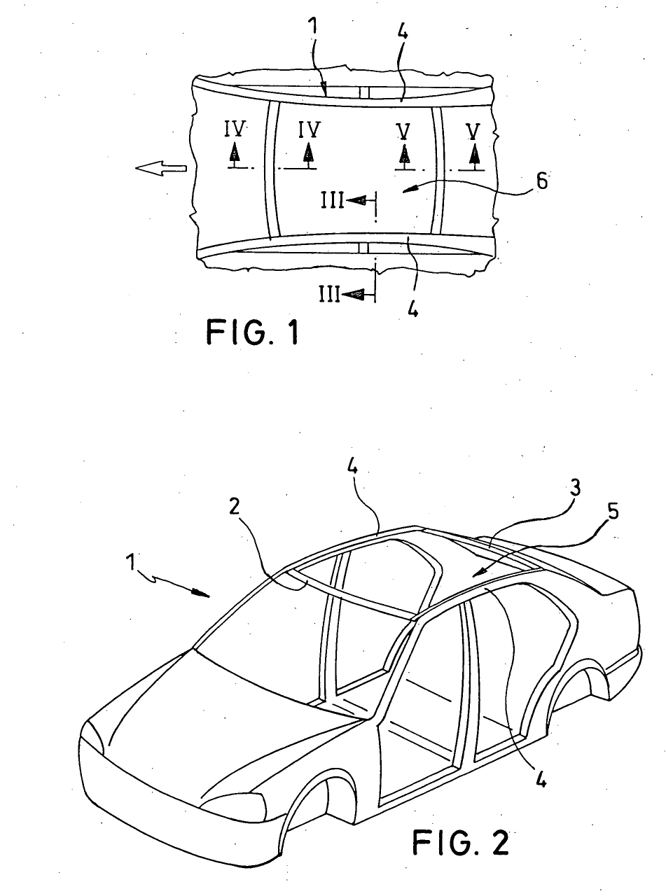

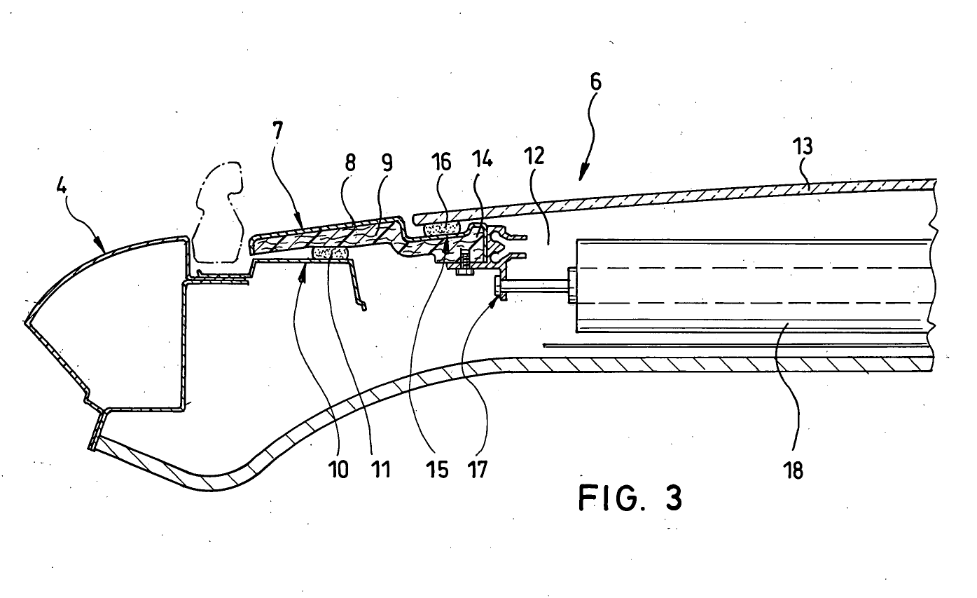

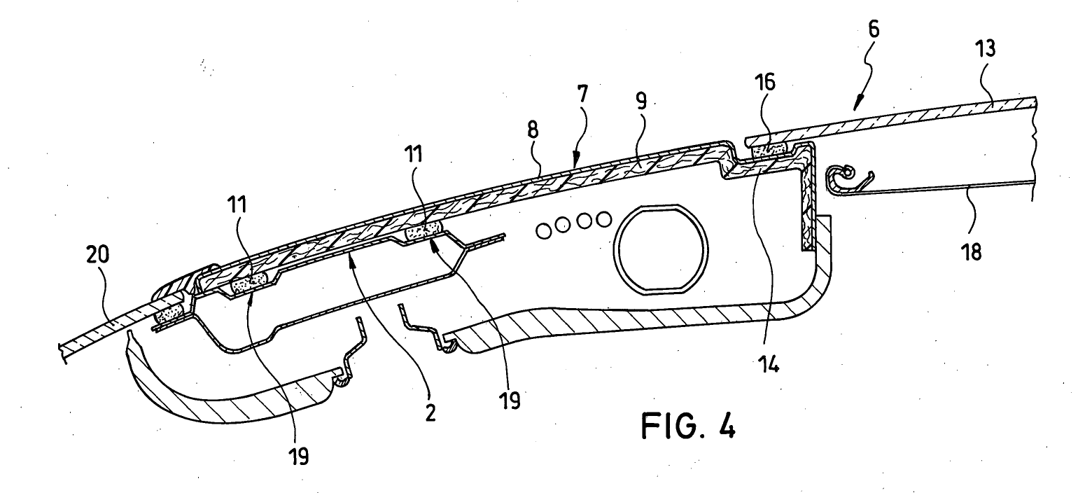

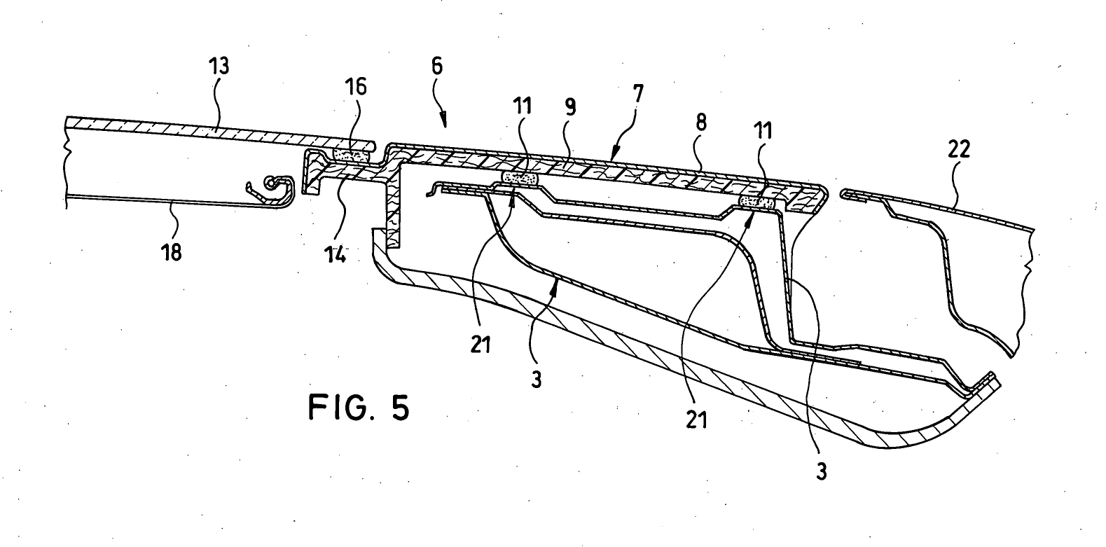

### DETAILED DESCRIPTION OF THE INVENTION

The roof 1 of a motor vehicle, especially of a passenger vehicle, contains a body-mounted roof frame with a front transverse roof frame 2, a rear transverse roof frame 3 and a longitudinal roof frame 4 at each lateral side, and which, together, surround a large-area upper opening 5 of the shell (see the shell of the motor vehicle which is shown in FIG. 2). To close the opening 5, and thus to complete the motor vehicle roof, there is a motor vehicle roof module 6 which has a composite component 7 with an external fixed roof skin 8 and a stiffening structure 9 which is securely attached to the bottom of the roof skin 8 and is, for example, rear foaming LFI (long fiber injection), a paper honeycomb structure which is foamed on, for example, with polyurethane foam or in general is any material which has been foamed in a tool.

The bottom of the composite component 7 of the motor vehicle roof module 6 is attached, for example, by means of cement beads 11 to flanges 10 of the longitudinal roof frame 4 and to flanges or support surfaces 19 of the front transverse roof frame 2 to which also a windshield 20 is attached, and to flanges or support surfaces 21 of the transverse rear roof frame 3 which is bordered to the rear by a rear hatch 22. On the outer peripheral edge of the composite component 7, the roof skin 8 is bent down as an outer limit and the stiffening structure 9 ends with the bottom edge of the bent-down roof skin 8.

Furthermore, the composite component 7 contains at least one large-area roof opening 12 which is covered by a fixed glass cover 13. On the inner edge area 14 of the composite component 7, which area borders the roof opening 12, the roof skin 8 is lowered and forms a support flange 15 to which the glass cover 13 is attached by means of a cement bead 16. Moreover a bearing means 17 for a sunshade 18 is attached to the inner edge area 14 of the composite component 7.

Instead of the fixed glass cover 13, a roof closing means with at least one movable cover part, for example, a sliding roof, a louvered roof, a spoiler roof or the like, can be provided instead. In such a case, on the inner edge area 14 of the composite component 7, a guide and bearing means of the roof closing means is attached and a seal for sealing the closed cover part relative to the composite component 7 is attached to the support flange 15.

The roof skin is produced, for example, from a plastic film or from an enameled or coated (foil-coated) sheet metal, especially aluminum sheet metal. Here, the surface of the roof skin 8 is configured or formed such that its appearance is matched to the surface of the cover 13 of the roof closing unit and has especially the same appearance so that the motor vehicle roof has an appearance of a large-area unit as far as the peripheral edges. A configuration in which a glass cover 13 is used and the surface of the composite component 7 and of the roof skin 8 acquires, such a glassy or glass-like appearance is especially preferred. This can take place, for example, by enameling or painting in a color or a dark gray shade which corresponds to the glass color of an uncolored or also tinted glass especially when the glass cover 13 is viewed obliquely from the side.

The surface of the composite component 7 can also form an optical unit jointly with the surface parts of the lateral longitudinal roof members 4.

1. Process for producing a motor vehicle roof with a roof module which is formed as a composite component with an outer roof skin and a stiffening structure which is attached to its inside, the composite component being formed with a roof opening, and with a roof closing unit which closes the roof opening added to it, comprise the steps of:
selecting a roof closing unit which is of generic construction,
producing a composite component of a dimensioning and surface configuration that is matched to the selected roof closing unit and a dimensioning matched to a body roof frame of a vehicle in which the roof module is to be installed.

2. Process as claimed in claim 1, wherein the roof skin is formed from plastic or metal and the stiffening structure is attached to the inside of the roof skin as a foamed-on part which contains reinforcing material.

3. Process as claimed in claim 1, wherein the roof skin of the component is produced with a surface having an identical appearance to that of a cover of the roof closing unit.

4. Process as claimed in claim 3, wherein said surface is provided with a glassy or glass-like appearance.

5. Motor vehicle roof with a roof module which is formed as a composite component with an outer roof skin and a stiffening structure which is attached to its inside, the composite component being formed with a roof opening and having a roof closing unit which closes the roof opening, wherein the roof closing unit is of generic construction, and wherein the composite component is of a size and shape for fitting the roof closing unit to a given vehicle body frame, having a dimensioning and surface configuration match to the roof closing unit of generic construction and a dimensioning matched to the given body roof frame.

6. Motor vehicle roof as claimed in claim 5, wherein the roof skin of the roof module is made of plastic or metal and the stiffening structure is attached to the inside of the roof skin and is a foamed-on part which contains a reinforcing material.

7. Motor vehicle roof as claimed in claim 5, wherein the roof closing unit has a cover, and wherein the roof skin has an outer surface of the same appearance as that of the cover.

8. Motor vehicle roof as claimed in claim 7, wherein said outer surface has a glassy appearance.
